(19) United States
(12) Patent Application Publication
(10) Pub. No.: US 2003/0066700 A1
(43) Pub. Date: Apr. 10, 2003

(54) Security vehicle system, vehicle and associated methods

(75) Inventor: Louis Marrero, Titusville, FL (US)

Correspondence Address: Allen, Dyer, Doppelt, Milbrath & Gilchrist, P.A., Attorneys-At-Law, 255 S. Orange Avenue, Suite 1401, P.O. Box 3791, Orlando, FL, 32802-3791, US

(73) Assignee: OMNICS INTERNATIONAL CORPORATION

(21) Appl. No.: 09/975,095

(22) Filed: Oct. 10, 2001

(51) Int. Cl. B62D 1/24

(52) U.S. Cl. 180/167; 340/825.72

(57) ABSTRACT

A security vehicle system and a security vehicle is provided. The security vehicle system preferably includes a remote controller and a security vehicle. The security vehicle preferably includes a security vehicle having a main body, a cargo receiving area adapted to receive cargo, at least one security device connected to the main body, a plurality of omni-directional wheels connected to the main body to provide multi-directional movement of the security vehicle, a control signal receiver, and at least one drive assembly connected to the main body and to the plurality of omni-directional wheels to drive the plurality of omni-directional wheels. The security vehicle preferably has a vertical height less than about twelve inches to thereby define a security vehicle having a low clearance.

### RELATED APPLICATIONS

The present application is related to patent application Ser. No. ______, titled OMNI-DIRECTIONAL WHEEL AND ASSOCIATED METHODS filed on the same date herewith by the same inventor and which is incorporated herein in its entirety by reference.

### FIELD OF THE INVENTION

The present invention relates to security vehicle systems and more particularly the field of security vehicles and associated methods.

### BACKGROUND OF THE INVENTION

Areas that are hard to access, i.e., areas having a low clearance or containing many obstacles, can only generally be monitored from a distance. For example, if surveillance is to be conducted near an area having a low clearance or containing many obstacles, i.e., conducting surveillance on a vehicle or within a predetermined area having many obstacles, such as an office, it is difficult to position a surveillance vehicle therein while simultaneously concealing the surveillance or security. Some alternatives include planting listening devices or video cameras, for example, in areas where they are not likely to be found. These listening and video devices, however, are not mobile and cannot follow an object in motion, such as a vehicle. Further, these devices can be difficult and time consuming to install.

Surveillance vehicles and systems are generally known and have been used in the surveillance industry for many years. For example, U.S. Pat. No. 4,709,265 titled “Remote Control Mobile Surveillance System” by Silverman et al. discloses a surveillance vehicle used to monitor an environment. This surveillance vehicle, however, is rather cumbersome and limited in directional positioning. These limitations on the vehicle are disadvantageous if the vehicle is to be used in an area having a low clearance or an area having many obstacles blocking a clear path of travel, e.g., a warehouse having many boxes of cargo positioned on pallets or in an aircraft cargo hold having cargo packed tightly therein.

### SUMMARY OF THE INVENTION

With the foregoing in mind, the present invention advantageously provides a security vehicle system including a security vehicle having a low clearance and multi-directional movement capabilities and associated methods. The present invention also advantageously provides a security vehicle that is light-weight and easy to maneuver. The security vehicle of the present invention is further advantageously modular so that it can be adapted with many different types of security devices depending on the type of security or surveillance that is to be conducted and has modules or portions that are readily interchangeable with like modules in other portions of the vehicle. This, in turn, advantageously reduces the number of parts for the vehicle, makes it much easier to manufacture, and makes it much easier to replace damaged or lost parts of the vehicle.

More particularly, the present invention provides a security vehicle system having a predetermined effective range. The security vehicle system preferably includes a remote controller having a control signal emitter positioned to emit a control signal. The security vehicle system also preferably includes a security vehicle having a main body including a front, a rear, and first and second sides extending between the front and rear. The security vehicle also preferably includes a medial body portion having a cargo receiving area adapted to receive cargo, at least one security device connected to the main body, and a plurality of omni-directional wheels connected to the main body to provide multi-directional movement of the security vehicle. The security vehicle also preferably includes a control signal receiver connected to the main body and positioned to receive the control signal emitted from the control signal emitter of the remote controller and at least one drive assembly connected to the main body and to the plurality of omni-directional wheels and responsive to the control signal emitted by the control signal emitter of the remote controller to drive the plurality of omni-directional wheels. The security vehicle preferably has a vertical height less than about twelve inches to thereby define a security vehicle having a low clearance so that the security vehicle can be readily positioned and maneuvered within a predetermined area having a low clearance.

The present invention also includes a security vehicle having a predetermined effective range and a low vertical height to thereby define a low clearance so that the security vehicle can be readily positioned and maneuvered within a predetermined area having a low clearance. The security vehicle preferably includes a main body having a front, a rear, first and second sides extending between the front and rear, and a medial body portion having at least one security device connected thereto. The main body preferably has a vertical height less than about twelve inches. The security vehicle also preferably includes a forward drive unit having a front, a rear, first and second sides extending between the front and rear positioned adjacent the respective first and second sides of the main body. The rear of the forward drive can advantageously be interchangeably connected to the front of the main body so that the forward drive unit is positioned to extend from the front of the main body. The forward drive unit preferably includes respective first and second omni-directional wheels connected to the respective first and second sides of the forward drive unit, and respective first and second forward drive assemblies connected to the respective first and second omni-directional wheels to drive the respective first and second omni-directional wheels. The forward drive unit can advantageously have a vertical height less than about twelve inches.

The security device also preferably includes a rear drive unit having a front, a rear, and first and second sides extending between the front and rear positioned adjacent the respective first and second sides of the main body. The front of the rear drive can advantageously be interchangeably connected to the rear of the main body so that the rear drive is positioned to extend from the rear of the main body, respective first and second omni-directional wheels connected to the respective first and second sides of the rear drive unit, and respective first and second rear drive assemblies connected to the respective first and second omni-directional wheels to drive the respective first and second omni-directional wheels. The rear drive unit preferably has a vertical height less than about twelve inches. The forward drive unit and the rear drive unit can advantageously be interchangeable so that the rear drive unit can be connected to the front of the main body and the forward drive unit can be connected to the rear of the main body.

The security device of the present invention can further preferably include a plurality of power units positioned to interchangeably connect to the main body, the forward drive unit, and the rear drive unit, to provide power to the respective first and second drive assemblies of the respective forward and rear drive units. Each of the plurality of power units can advantageously have a vertical height less than about twelve inches.

The present invention also preferably includes a method of maneuvering a security vehicle having a base with a longitudinal axis, a low clearance, and at least one security device connected thereto. The method preferably includes moving the security vehicle in a first predetermined direction so that the longitudinal axis of the vehicle is substantially parallel to the path of travel of the security vehicle. The method can also preferably include moving the security vehicle in a second predetermined direction so that the longitudinal axis of the vehicle is substantially perpendicular to the path of travel of the security vehicle. The method can further preferably include moving the security vehicle in a third predetermined direction so that the longitudinal axis of the vehicle is substantially transverse to the path of travel of the security vehicle.

The present invention further preferably includes a method of conducting surveillance with a security vehicle having a base with a longitudinal axis, a lateral axis, at least one security device connected thereto. The method preferably includes moving the security vehicle in a first predetermined direction so that the longitudinal axis is substantially parallel with a path of travel of the security vehicle and the lateral axis is substantially perpendicular with the path of travel of the security vehicle. The method also preferably includes extending the at least one security device from the security vehicle to thereby expand the predetermined effective range of the security vehicle. The method further preferably includes moving the security vehicle in a second predetermined direction so that the longitudinal axis is substantially perpendicular to the path of travel of the security vehicle and the lateral axis is substantially parallel to the path of travel of the security vehicle.

The security system, device, and methods of the present invention advantageously allow for surveillance to be conducted in areas having narrow paths of travel and a low clearance. The present invention also advantageously allows a security vehicle to be maneuvered around obstacles positioned in the path of travel of the security vehicle. The present invention further advantageously allows a security vehicle to be maneuvered on many different types of terrains, i.e., smooth, ice, mountainous, roughened, rains, and wet surfaces. The present invention still further advantageously provides interchangeable front and rear drive units as well as interchangeable power units. This advantageously allows for a portion of a security vehicle to be replaced instead of a need to replace the entire security vehicle. This also advantageously allows for the plurality of power units to be interchanged between various portions of the security vehicle. Further, the interchangeability of the power units also allows for the user to have additional charged power units available that can be adapted to replace a power unit that has lost its charge, regardless of the location of the power unit.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a fragmentary environmental view of a security vehicle being used on board a commercial aircraft according to the present invention;

FIG. 2 is an environmental view of a security vehicle system according to the present invention;

FIG. 3 is a front perspective view of a security vehicle according to the present invention;

FIG. 4 is a top perspective view of a security vehicle having the top removed according to the present invention;

FIG. 5 is an exploded perspective view of security vehicle having the top removed according to the present invention;

FIG. 6 is a top plan view of a security vehicle showing the range of motion according to the present invention;

FIG. 7 is a side elevation view of a pair of security vehicles having varying heights according to the present invention;

FIG. 8 is an exploded perspective view of a security vehicle showing the omni-directional wheels removed and a pair of tracks being connected to the vehicle according to the present invention;

FIG. 9 is a top perspective view of a security vehicle showing a main body, forward drive unit, rear drive unit and a plurality of power units connected thereto according to the present invention;

FIG. 10 is an exploded perspective view of a security vehicle showing the interchangeability of the forward and rear drive units and the power units according to the present invention;

FIG. 11 is a perspective view of a security vehicle having a forward and rear drive unit, a plurality of power units, and a pair of tracks connected thereto according to the present invention;

FIG. 12 is a side elevation view of an omni-directional wheel according to the present invention;

FIG. 13 is another side elevation view of an omni-directional wheel according to the present invention;

FIG. 14 is a exploded perspective view of an omni-directional wheel according to the present invention;

FIG. 15 is a front perspective view of a security vehicle having a camera positioned in a cavity of the main body according to the present invention;

FIG. 16 is a front perspective view of a security vehicle having a fire extinguishing device extending outwardly therefrom according to the present invention;

FIG. 17 is a flow chart showing the use of the security vehicle system according to the present invention;

FIG. 18 is a schematic diagram showing a control signal in the security vehicle system according to the present invention; and

FIG. 19 is a perspective view of a security vehicle having security devices positioned therein according to the present invention.

### DETAILED DESCRIPTION OF THE PREFERRED EMBODIMENTS

The present invention will now be described more fully hereinafter with reference to the accompanying drawings which illustrate preferred embodiments of the invention. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, the prime notation, if used, indicates similar elements in alternative embodiments.

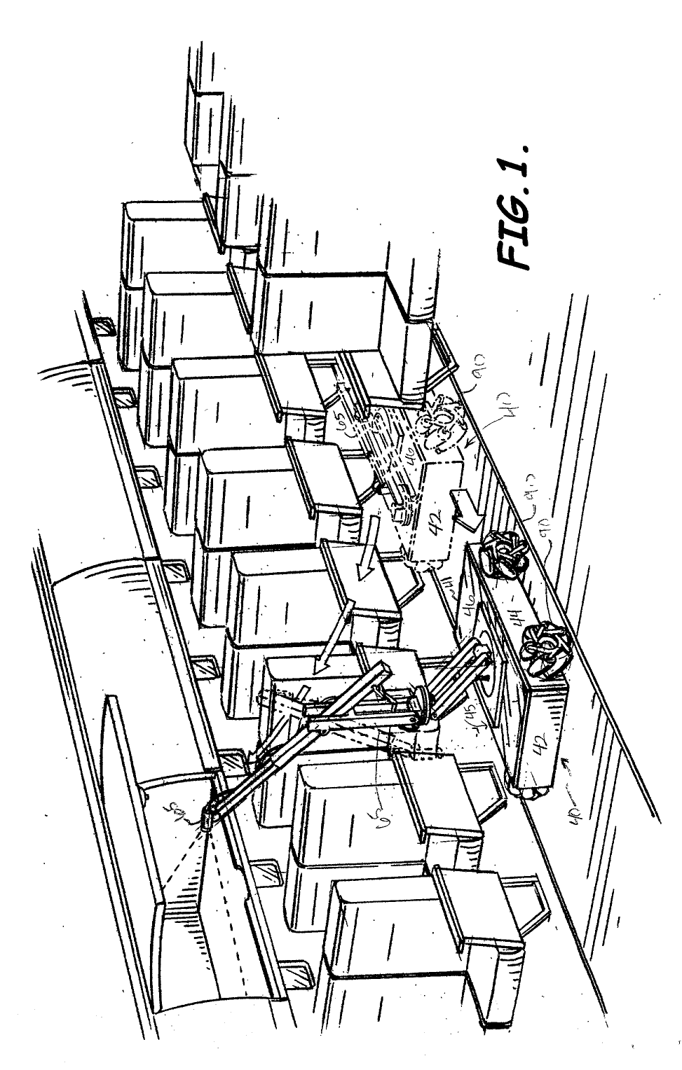

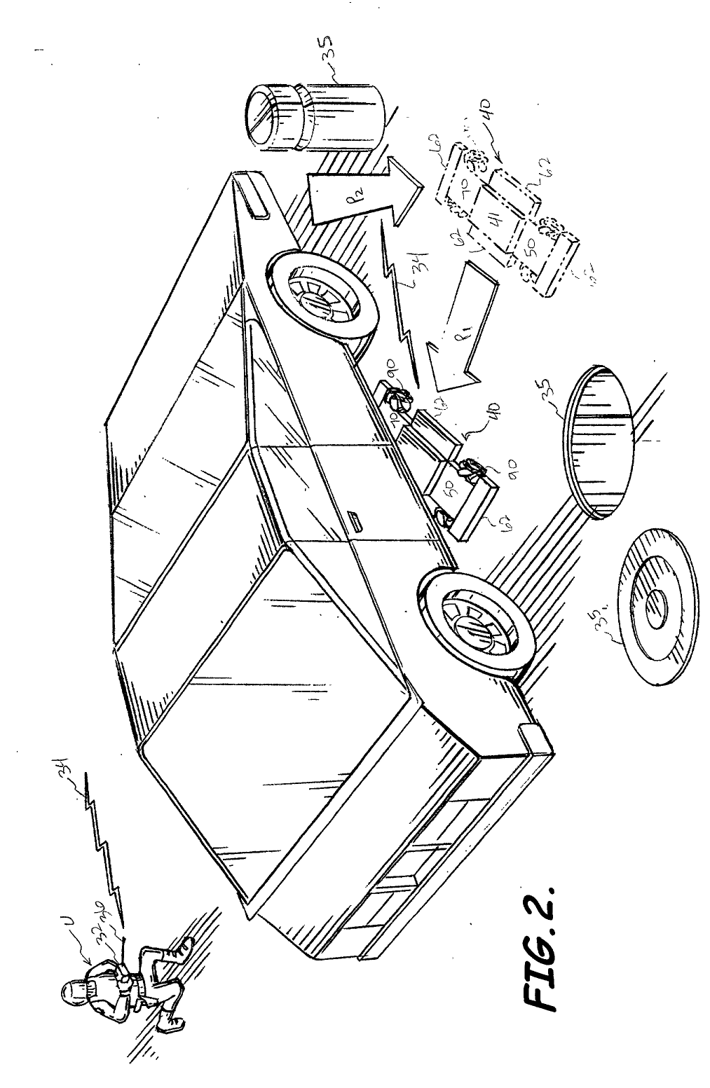

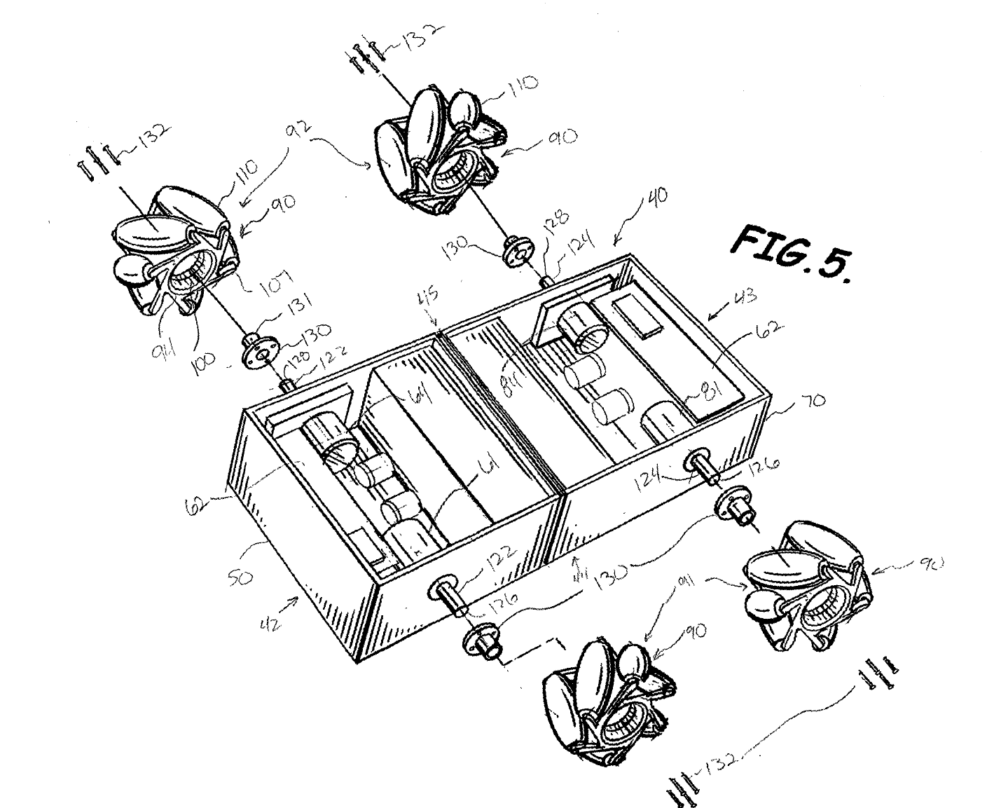

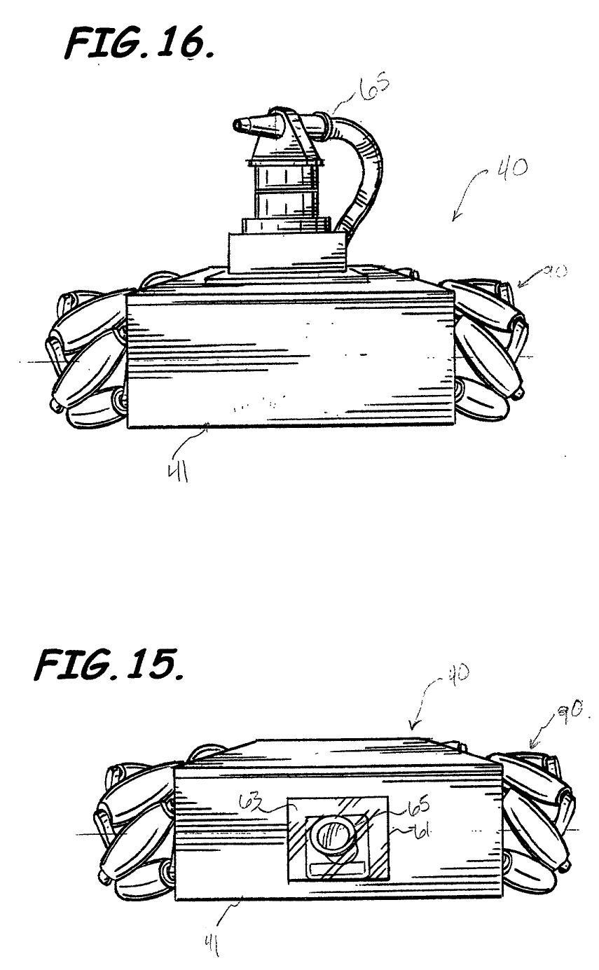

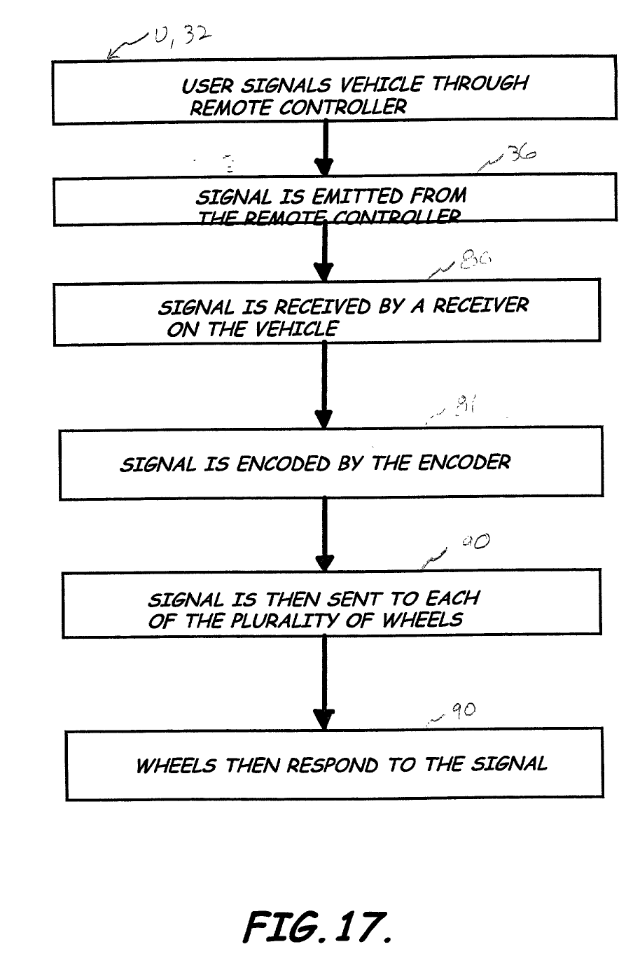

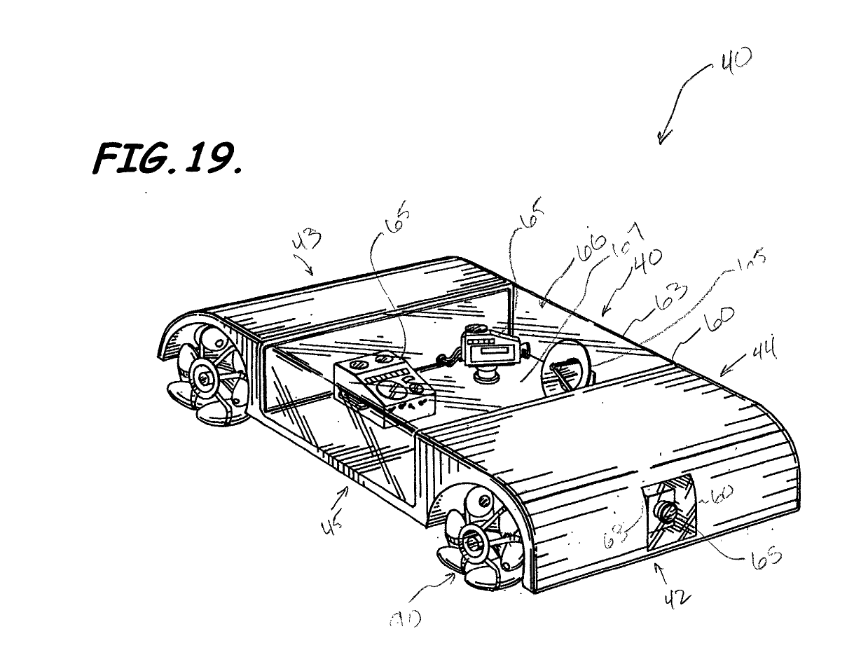

As best illustrated in FIGS. 1-19, the present invention advantageously provides a security vehicle system 30, a security vehicle 40, an omni-directional wheel 90, and associated methods. More particularly, as best illustrated in FIGS. 1 and 2, the security vehicle system 30 of the present invention includes a remote controller 32 and a security vehicle 40 to access areas having a low clearance or having many obstacles 35 positioned therein, such as on an aircraft for example. The security vehicle 40 of the security vehicle system 30 and of the present invention can advantageously include at least one security device 65 connected thereto. As best illustrated in FIGS. 15 and 16, the security device 65 can be any number of security devices, such as a bomb detection device, a bomb disarming device, a fire detection device, a fire extinguishing device, a poison detection device, a poison disabling device, a camera, a listening device, a water purity testing device, or any other types of security and surveillance devices as understood by those skilled in the art. The security device 65 can also advantageously be provided by a plurality of security devices. For example, a security vehicle 40 having a fire extinguishing device connected thereto would preferably also include a camera so that the user U can verify the location of the security vehicle 40. The security vehicle system 30 includes a predetermined effective range, e.g. ten feet. The predetermined effective range can be controlled by the distance that the security device 65 can be effectively used without moving the security vehicle 40. For example, the effective range of a camera may be ten feet but can be increased to twenty feet if the camera or the security vehicle 40 upon which the camera is mounted is moved.

As best illustrated in FIG. 2, the remote controller 32 of the security vehicle system 30 can advantageously include a control signal emitter 36 positioned to emit a control signal 34. The control signal 34 can advantageously be adapted to travel over great distances or over shorter distances as understood by those skilled in the art. The control signal 34 emitted by the control signal emitter 36 can advantageously be a radio frequency, microwave frequency, an infra red communication link, a satellite communications link, or any other type of control signal as understood by those skilled in the art.

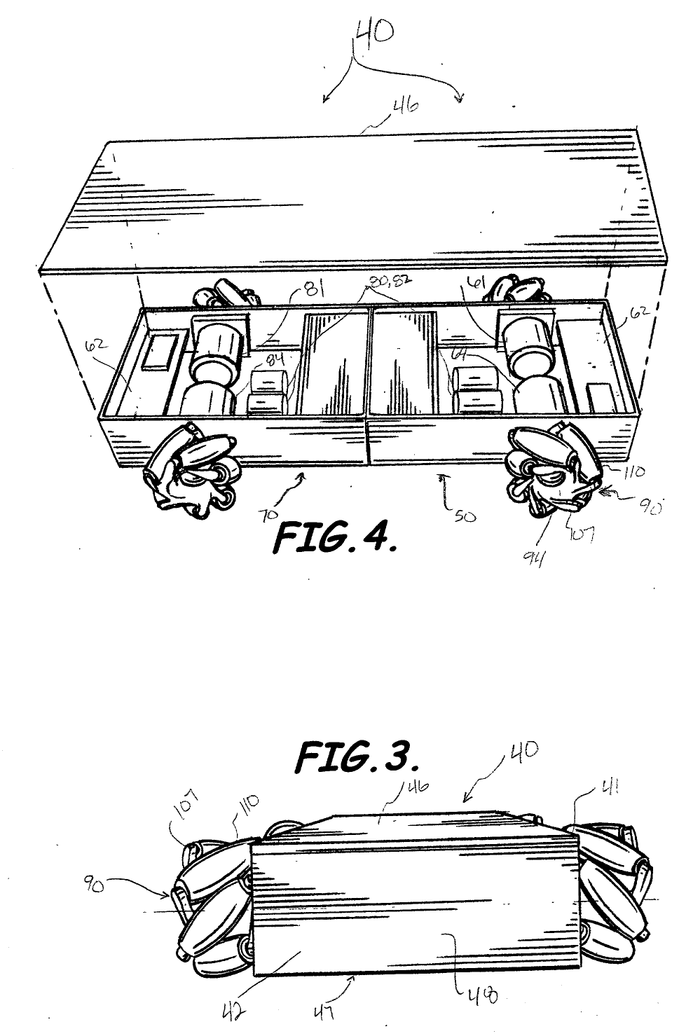

As best illustrated in FIGS. 3-7, the present invention and the security vehicle system 30 include a security vehicle 40. As described above, the security vehicle 40 preferably has a predetermined effective range and a low vertical height to thereby define a low clearance security vehicle. The security vehicle 40 includes a main body 41 having a bottom 47, a top 46, a plurality of side walls 48 extending therebetween, a front 42, a rear 43, and first and second sides 44, 45 extending between the front 42 and the rear 43. The main body 41 of the security vehicle 40 can advantageously be formed of aluminum, for example, or any other material that is light in weight, relatively strong, heat resistant, water resistant, and non-corrosive.

The main body 41 of the security vehicle 40 can also advantageously include a medial body portion 49 having a cargo receiving area 66 adapted to receive cargo. For example, the cargo can be a security device 65, such as those described above. The cargo receiving area 66 can also advantageously be used to transport hazardous cargo into or out of a hazardous area, e.g., the security vehicle 40 can be positioned into an area having a hazardous material spill and a hazardous material technician working in the contaminated area can insert a sample into the cargo receiving area 66 to be analyzed at an off site lab. In this scenario, the security vehicle 40 can also be adapted to sample air quality in the contaminated area and bring the sample out to an uncontaminated area to be analyzed. This advantageously decreases the risks taken by an operator by increasing a distance between the operator and the hazardous material.

The cargo receiving area 66 of the security vehicle 40 can further include a cavity 67 positioned between the sidewalls 48 adjacent the front 42, rear 43, and first and second sides 44, 45 of the main body 41. The security device 65 can advantageously be positioned to extend from the cargo receiving area 66 to thereby increase the predetermined effective range of the security vehicle 40 as described above and as illustrated in FIG. 1.

The security device 65 can, for example, be positioned in a retracted position so that the security vehicle 40 can maintain a low vertical clearance. The security device 65 can then be extended out of the cavity 67, as illustrated in FIG. 1 by a camera being extended out of the top of the security vehicle 40, for example. Extending the security device 65 out of the cavity 67 advantageously provides the security vehicle 65 with a greater effective area. For example, when the camera illustrated in FIG. 1 is positioned in the retracted position, it can only be positioned to view areas directly in front of the security vehicle 40. When the camera is extended upwardly and pivoted, however, as illustrated in FIG. 1, the camera can advantageously be used to view areas surrounding the security vehicle 40.

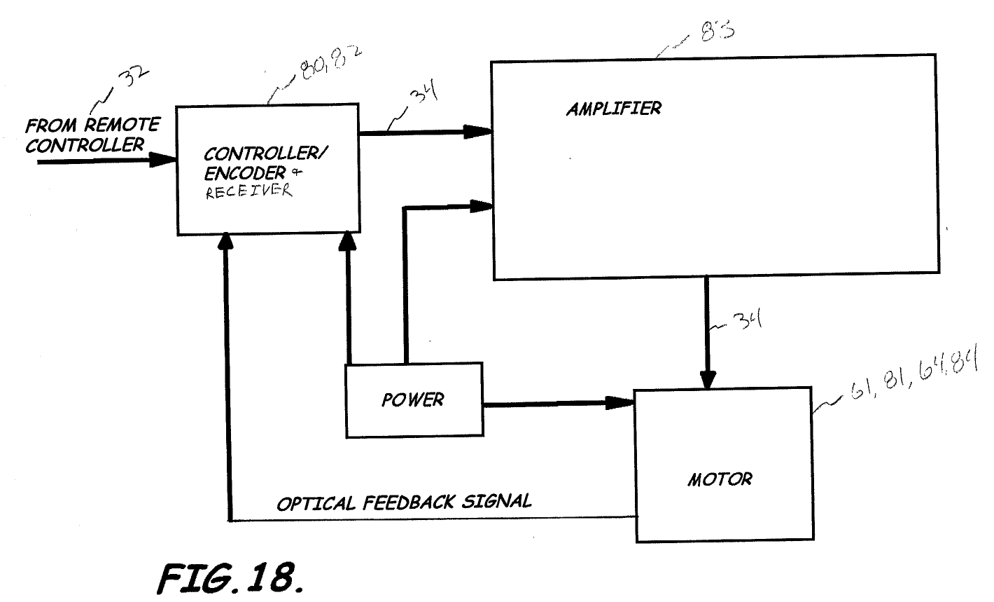

The security vehicle system 30, and security vehicle 40 of the present invention can also advantageously include a plurality of omni-directional wheels 90 connected to the main body 41 of the security vehicle to provide multi-directional movement to the security vehicle 40. The security vehicle 40 can also advantageously include a controller connected to the main body 41 of the security device 40 to receive the control signal 34 emitted from the control signal emitter 36. The controller can advantageously include a control signal receiver 80 and a control signal encoder 82 positioned in communication with the control signal receiver 80 to encode the control signal 34. More particularly, the security vehicle 40 can further advantageously include one controller per omni-directional wheel 90. Each of the controllers are positioned to receive the control signal 34, encode the control signal, send that signal, i.e., the encoded signal, to the omni-directional wheel, and send the encoded signal back to the controller as confirmation that the instruction contained in the signal has been carried out. The security vehicle 40 is the responsive to the encoded control signal. For example, as best illustrated in FIG. 18, the control signal receiver 80 can advantageously be provided by a controller positioned to receive the control signal 34 from the remote controller 32. The control signal 34 is encoded by the control signal encoder 82 and passed through an amplifier 83 where it can advantageously be strengthened, or amplified. The security vehicle 40 is then responsive to the encoded signal, an optical feedback signal 84 is sent back to the control signal receiver/encoder 80, 82 to verify that the control signal 34 sent by the remote controller 32 has been carried out by the security vehicle 40. Although FIG. 18 illustrates the signals being transmitted in one direction, it shall be understood that the signals can be transmitted in a two way directional configuration as understood by those skilled in the art.

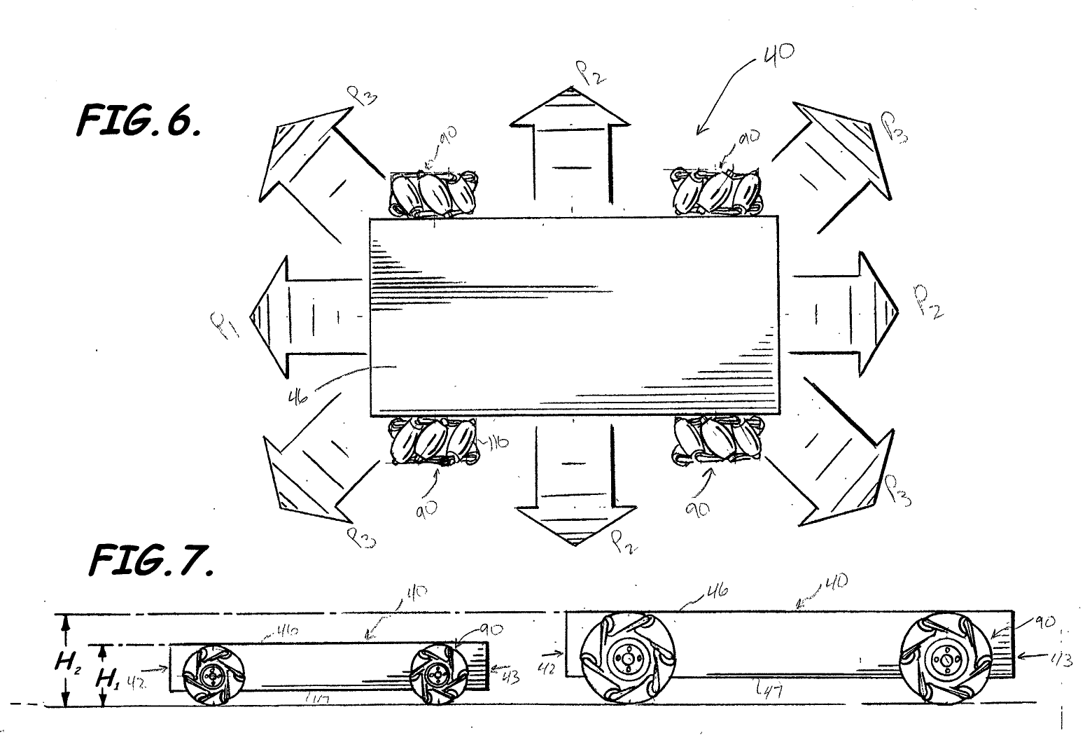

As best illustrated in FIG. 7 the security vehicle 40 can advantageously have various vertical heights H₁, H₂. It is preferable, however, that the security vehicle 40 height is less than about twelve inches, and more preferably between the range of about four to seven inches. The security vehicle 40 can advantageously have a width of between about ten to twenty-four inches, but preferably about seventeen inches. A width of seventeen inches is preferable because this is approximately the width of a conventional aisle in an commercial airplane. Similarly, a security vehicle 40 having a vertical height between about four to seven inches is advantageous because it can readily be positioned to extend beneath cars, as best illustrated in FIG. 1 and within spaces encountered on a commercial airplane, as best illustrated in FIG. 2.

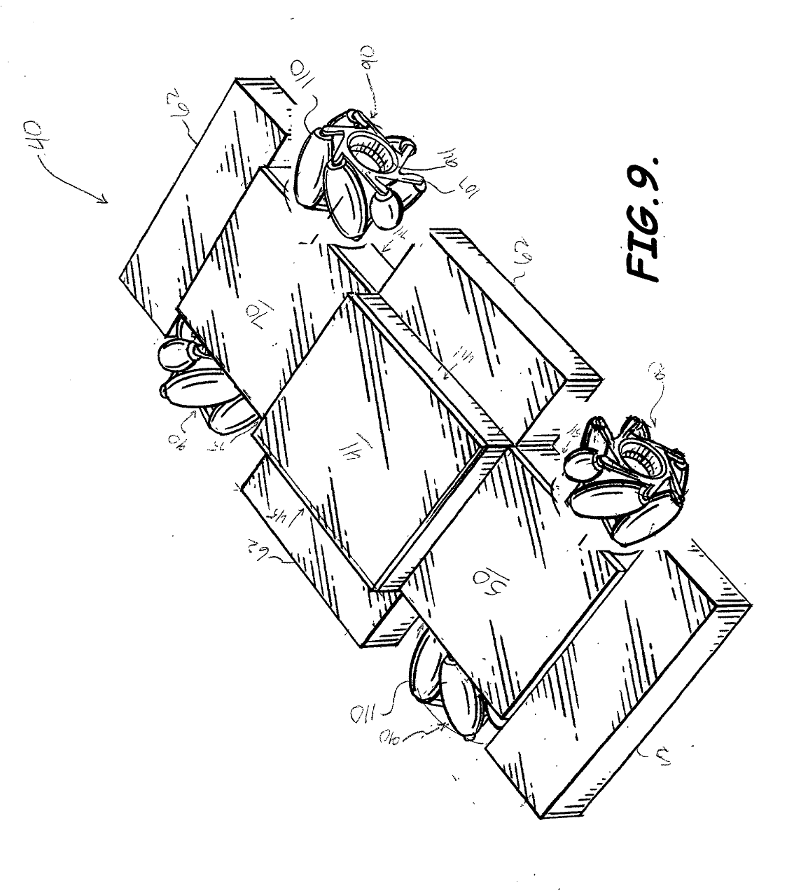

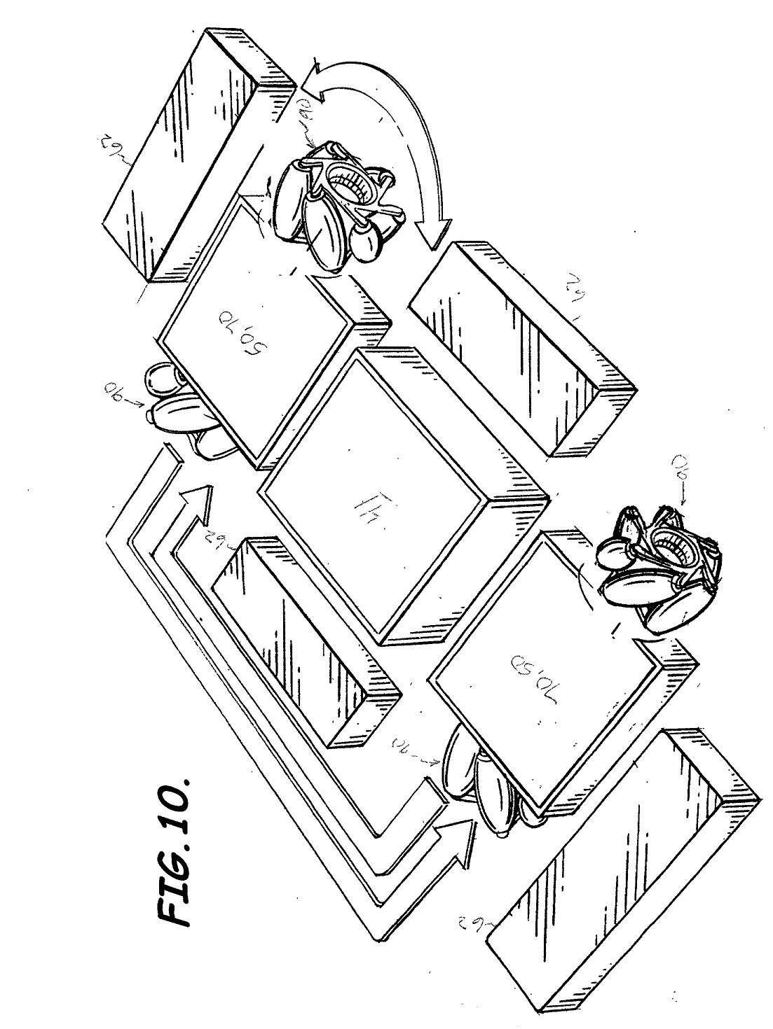

As best illustrated in FIGS. 9-10, the security vehicle 40 of the present invention and of the security vehicle system 30 can further advantageously include a forward drive unit 50, and a rear drive unit 70 positioned to detachably and interchangeably connect to the respective front 42 and rear 43 of the main body. The forward and rear 50, 70 drive units can advantageously each include a front 52, 72, a rear 53, 73, first 54, 74 and second 55, 75 sides extending between the front 52, 72 and rear 53, 73 positioned adjacent the first 44 and second 45 sides of the main body 41. The rear of the forward drive unit 53 can advantageously be interchangeably connected to the front of the main body 42 so that the forward drive unit 50 is positioned to extend from the front of the main body 42. Similarly, the front of the rear drive unit 72 can advantageously be interchangeably connected to the rear of the main body 43 so that the rear drive 70 is positioned to extend from the rear of the main body 43. Respective first and second omni-directional wheels 91, 92 are connected to the respective first and second sides of the respective front 54, 55 and rear 74, 75 drive units. The forward drive unit 50 can advantageously include first and second forward drive assemblies 61, 64 connected to the respective first and second omni-directional wheels 91, 92 to drive the respective first and second omni-directional wheels 91, 92. Similarly, the rear drive unit 70 can advantageously include first and second rear drive assemblies 81, 84 connected to the respective first and second omni-directional wheels 91, 92 to drive the respective first and second omni-directional wheels 91, 92. Similar to the main body of the security vehicle, and as illustrated in FIGS. 9 and 10, both the front and rear drive units 50, 70 can advantageously include a vertical height less than about twelve inches, and preferably less than about eight inches. For example, security vehicles with a vertical height of about 2 to 7 inches are more preferable such as 4 inches and 7 inches for selected applications.

As mentioned above and as best illustrated in FIG. 10, the front and rear drive units 50, 70 can advantageously be interchangeably connected to the main body of the security device 41. For example, the front drive unit 50 can advantageously be connected to the rear of the main body 43 and the rear drive unit 70 can advantageously be connected to the front of the main body 42. This advantageously allows for ready assembly of a security device that is shipped in pieces, for example. This also advantageously allows for quick replacement of a damaged unit without the need to replace the entire security vehicle 40.

The security vehicle 40 of the security vehicle system 30 and of the present invention advantageously includes a plurality of power units 62 positioned to interchangeably connect to the main body of the security vehicle 41, the forward drive unit 50 and the rear drive unit 70. As best illustrated in FIGS. 9-10, the plurality of power units 62 can be interchangeably connected to portions of the front and rear drive units 50, 70 and the main body of the security vehicle 41. The power units 62 can advantageously be batteries, for example, and more particularly, the batteries can advantageously be rechargeable lithium batteries or any other type of power unit 62 that has a long life as understood by those skilled in the art. This is advantageous because it allows for ready replacement of individual power units 62 no matter where they are positioned, i.e., one power unit 62 can be connected to portions of the main body of the security vehicle 41, the forward drive unit 50 or the rear drive unit 70 as needed. The plurality of power units 62 are connected to the forward drive unit 50, the rear drive unit 70, the control signal receiver 80, the control signal encoder 82, and the amplifier 83 to provide power to the respective forward drive assembly 50, the rear drive assembly 70, the control signal receiver 80, the control signal encoder 82, and the amplifier 83.

As best illustrated in FIG. 15, the side walls of the main body 48 further include a plurality of security device access openings 60 formed therein to provide ready access of the security device 65 positioned within the cargo receiving area 66 to an area positioned exterior the cargo receiving area 66. For example, as illustrated in FIG. 15, the security device access opening 60 can advantageously be a rectangular opening formed in a sidewall 48 adjacent the front of the main body 42 so that a camera can be positioned to view the area exterior the main body 41. The side walls of the main body 48 still further include a plurality of security device access opening covers 63 positioned to cover each of the plurality of security device access openings 60 when not in use by the security device 65. The security device access opening cover 63 can advantageously be positioned to protect the security device 65 positioned behind the security device access opening 60. For example, the security device access opening cover 63 can advantageously be a hard transparent plastic material positioned over the security device access opening 60 so that a security device 65, such as a camera, can still be used when the security device access cover 63 is engaged.

The security vehicle 40 can also advantageously include a pair of main axles 120 defined by a front main axle 122 connected between the respective first and second omni-directional wheels 91, 92 of the forward drive unit 50 and a rear main axle 124 connected between the respective first and second omni-directional wheels 91, 92 of the rear drive unit 70. The front and rear main axles 122, 124 can advantageously include a first end 126 positioned adjacent the first side of the main body 44 and a second end 128 positioned adjacent the second side of the main body 45. The front and rear main axles 122, 124 can advantageously be made of an aluminum material or any other type of material having light weight and high strength properties as understood by those skilled in the art. The front and rear main axles 122, 124 can also advantageously include a plurality of omni-directional wheel connectors 130 each connected to the respective first and second ends 126, 128 of the respective front and rear main axles 122, 124 and including one of the respective first and second ends 126, 128 of one of the respective front or rear main axles 122, 124 extending from a medial portion 131 thereof. Each of the plurality of omni-directional wheel connectors 130 can also advantageously include a plurality of lugs 132 positioned in an annular configuration surrounding the main axle 120 extending from the medial portion 131 of the omni-directional wheel connector 130. The omni-directional wheel connector 130 can advantageously be integrally formed with the main axle 120 to thereby increase the strength of the connection between the omni-directional wheel connector 130 and the main axle 120.

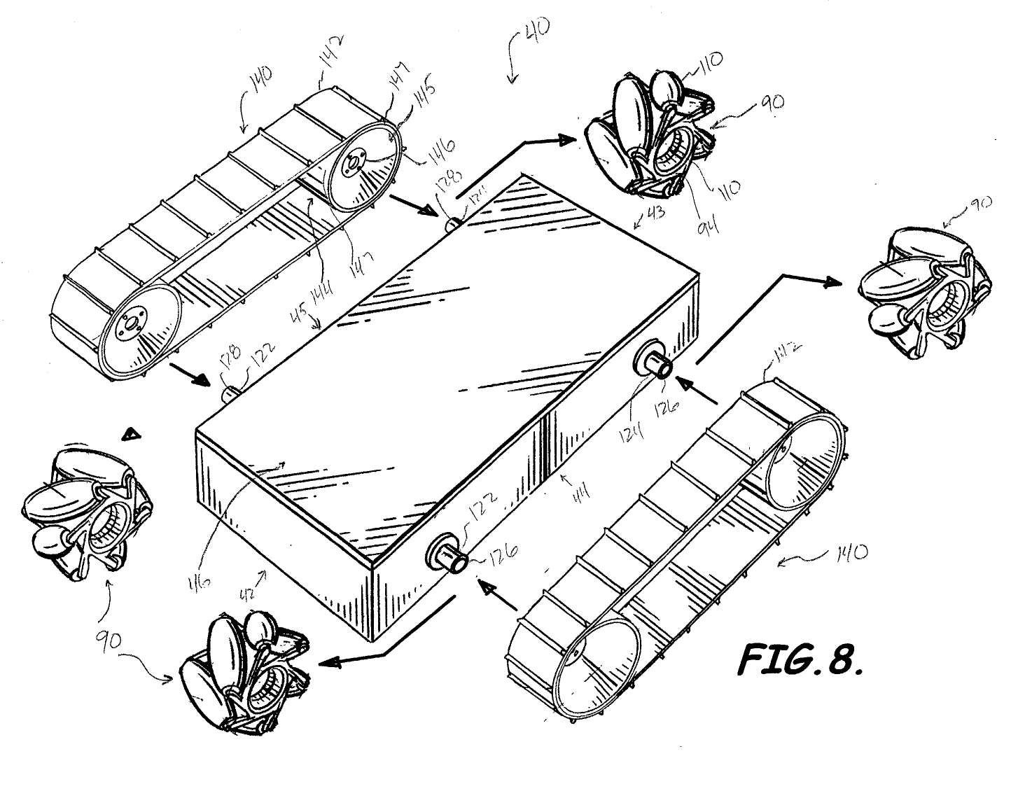

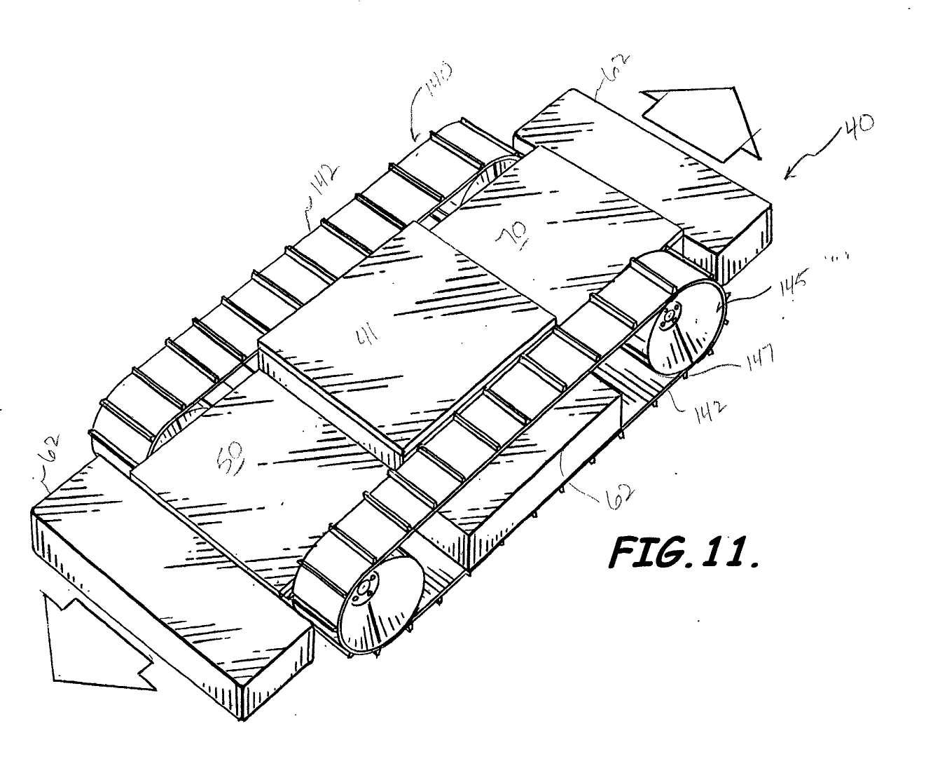

As best illustrated in FIGS. 8 and 11, the security vehicle system 30 and the security vehicle 40 of the present invention can advantageously include a track converter 140 positioned to replace the plurality of omni-directional wheels 90 with a pair of tracks 142. The track converter 140 can advantageously include a plurality of track receiving members 144 each having a size slightly larger than the size of each of the plurality of omni-directional wheels 90. The track receiving members 144 can advantageously be provided by a track wheel 145, for example, having a track wheel hub 146 and a track wheel rim 147. The track wheel rim 147, can advantageously be slightly raised so that a track wheel recess 148 is formed to receive the tracks 142. The track wheel recess 148 can advantageously be smooth for high speed travel, or roughened to thereby increase friction between the track wheel 145 and the track 142 during travel over rough terrain.

The track receiving members 144 can advantageously be positioned to connect to one of the plurality of omni-directional wheel connectors 130. The track wheel 145 can therefore have a configuration substantially similar to the configuration of the omni-directional wheel connector 130 to thereby insure that the track wheel 145 can be positioned to engage the omni-directional wheel connector 130. The pair of tracks 142 can then be positioned to connect between a pair of the track receiving members 144. Each of the tracks 142 can advantageously be made of a heavy-duty plastic material, or any other type of material that is flexible and has high strength properties as understood by those skilled in the art.

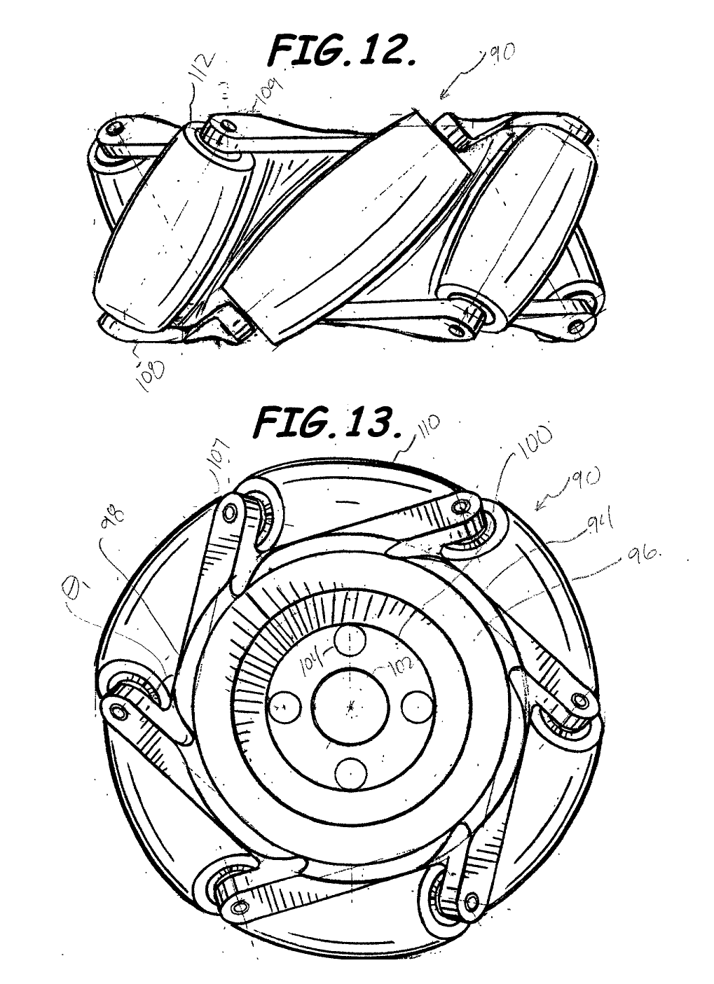

As best illustrated in FIGS. 12-14, the omni-directional wheel 90 of the security vehicle system 30, the security vehicle 40, and of the present invention advantageously includes a wheel hub 94 having a vertical height when positioned on a vehicle of less than about twelve inches and being formed of a plastic material. The wheel hub 94 can advantageously include a hub main body 96 having omni-directional wheel connecting means for connecting portions of the omni-directional wheel 90 to the security vehicle 40.

The omni-directional wheel connecting means can advantageously be provided by an axle mount 100 formed in a medial portion of the hub main body 96. The axle mount 100 can advantageously include a main axle receiving portion 102 and a plurality of lug receiving portions 104 formed in a medial portion thereof and positioned in an annular configuration to surround the main axle receiving portion 102. Each of the lug receiving portions 104 can advantageously be positioned to receive one of a plurality of lugs 132 extending outwardly from portions of a vehicle axis, i.e., the security vehicle main axle 120, to thereby secure the omni-directional wheel 90 to the vehicle. The main axle receiving portion 102 and the lug receiving portion can advantageously be openings formed in the hub main body 96. The lug receiving portions 104 can also advantageously include a configuration substantially similar to the configuration of the lugs 132 extending from the main axle 120. The hub main body 96 can further include an outer periphery portion 98 having a plurality of recesses 99 formed therein. Each of the plurality of recesses 99 can have a substantially arcuate shaped recessed surface formed therein. The recesses 99 can advantageously be positioned to extend across the outer peripheries 98 of the hub main body 96. The outer peripheries of the hub main body 98 can advantageously have a diameter D₁ that is about twice as large as a diameter D₂ of inner peripheries of the hub main body 96. This advantageously allows for simple molding of the wheel hub 94.

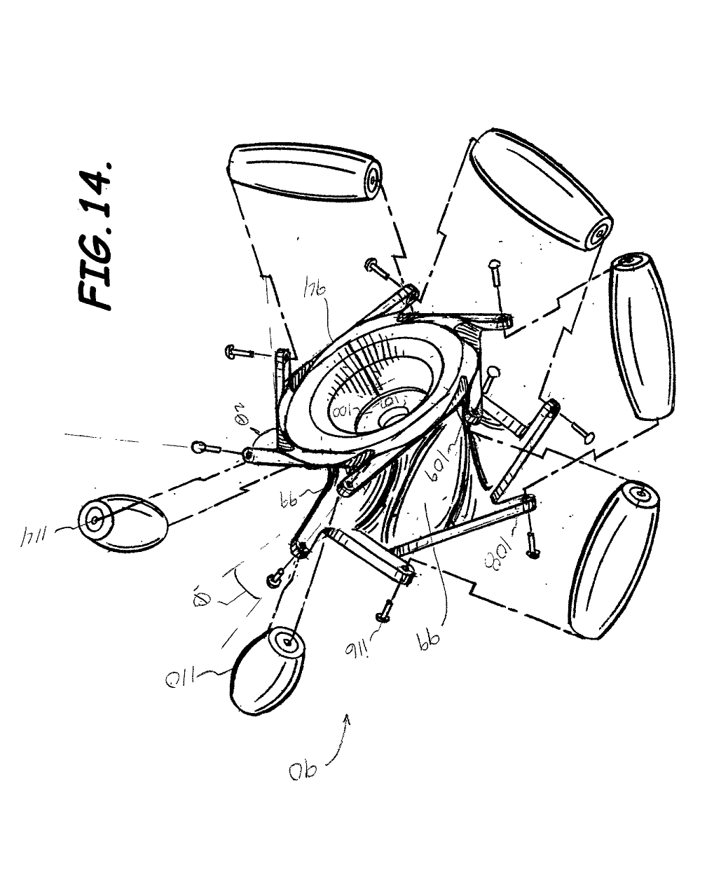

As best illustrated in FIG. 14, the omni-directional wheel 90 can also advantageously include wheel member mounting means integrally formed of substantially the same material as the wheel hub 94 and positioned to surround the outer peripheries 98 of the hub main body 90 and extend outwardly therefrom. The wheel member mounting means can advantageously be provided by a plurality of pairs of spaced-apart wheel member mounting arms 107 integrally formed of substantially the same material as the wheel hub 94. The wheel member mounting arms 107 can advantageously be positioned to surround the outer peripheries 98 of the hub main body 96 and extend outwardly therefrom. Each of the plurality of pairs of wheel member mounting arms 107 can advantageously be defined by a first wheel member mounting arm 108 having a first predetermined elevation X₁ and a second wheel member mounting arm 109 positioned substantially opposite the first wheel member mounting arm 108 and having a second different predetermined elevation X₂. The first and second predetermined elevations X₁, X₂ are different to thereby advantageously enhance the strength and efficiency of the omni-directional wheel 90.

The omni-directional wheel 90 can further advantageously include a plurality of separate and spaced-apart wheel members 110 positioned to connect to the wheel member mounting arms 107 and overlie the outer peripheries 98 of the hub main body 96. Each of the plurality of wheel members 110 are therefore adapted to operate independently of other ones of the plurality of wheel members 110 and independently of the wheel hub 94. Each of the plurality of wheel members 110 can therefore be rotated regardless of movement of the wheel hub 94. When one of the plurality of wheel members 110 is in contact with a support surface, such as the floor of an airplane cabin, the wheel member can be adapted to rotate, regardless of whether the wheel hub 94 is rotating. Each of the plurality of wheel members 90 can advantageously be connected to the wheel hub 94 to provide an omni-directional wheel 90 having a vertical height less than about twelve inches to thereby define an omni-directional wheel 90 having a low clearance. The vertical height of the omni-directional wheel, however, is preferably between the range of about four to seven inches as best illustrated in FIG. 6 and as indicated by H₁ and H₂. The vertical height of the omni-directional wheel 90 can be slightly larger than the vertical height of the side walls of the main body 48 of the security vehicle 40. The vertical height of the omni-directional wheel 90, therefore, controls the vertical height of the security vehicle 40. When the omni-directional wheels are mounted to the main body 41 of the security vehicle 40, the vertical height of the security vehicle 40, i.e., the main body 41 having the omni-directional wheels 90 connected thereto, does not exceed the vertical height of the omni-directional wheels 90.

Each one of the plurality of wheel members 110 of the omni-directional wheel 90 can further include a wheel main body 112 having a bulbous shape, a lateral axis, and a longitudinal axis being substantially longer than the lateral axis. Each one of the plurality of wheel members 110 can advantageously be connected between the first wheel member mounting arm 108 having the first predetermined elevation X₁ and the second wheel member mounting arm 109 having the second predetermined elevation X₂ and positioned to overlie one of the plurality of recesses 99. Each of the plurality of wheel members 110 are advantageously connected to the wheel hub 94 in a symmetrical configuration. Therefore each of the plurality of wheel members 110 are positioned substantially opposite the other ones of the plurality of wheel members 110. Further, the plurality of wheel members 110 preferably includes six wheels, but any number of wheel members 110 can be used to form the omni-directional wheel 90. For example, the plurality of wheel members 110 can include three upper wheel members 110 and three lower wheel members 110 positioned substantially opposite the upper wheel members and further positioned substantially symmetrical the upper wheel members.

As best illustrated in FIG. 14 each of the plurality of pairs of wheel member mounting arms 107 can advantageously extend at an angle θ₁ between about 30 and 60 degrees from the outer peripheries of the hub main body 98. The angle θ₁ between each of the pairs of wheel member mounting arms 107 and the hub main body 96, however, is preferably about 45 degrees. The second wheel member mounting arm 109 can advantageously be positioned at an angle θ₂ between about 30 and 60 degrees relative to the first wheel member mounting arm. Therefore, when each of the plurality of wheel members 110 are connected between the first and the second wheel member mounting arms 108, 109, each of the plurality of wheel members 110 will be tilted substantially the same angle θ₂ as the angle between the first and second wheel member mounting arms 108, 109. Each one of the plurality of recesses 99 can advantageously include a length substantially similar to a distance between the first and second wheel member mounting arms 108, 109.

The wheel hub 94, the wheel member mounting arms 107, and the plurality of wheel members 110 are all formed of a plastic material. The plastic material is preferably polyurethane, but any other plastic material that can be easily molded, has high strength properties and is light in weight can also be used as understood by those skilled in the art.

As best illustrated in FIG. 14, the omni-directional wheel 90 of the present invention, the security vehicle 40, and the security vehicle system 30, can also advantageously include a plurality of wheel member mounting rods 114 each positioned to extend through a medial portion of the wheel main body 112 of each of the plurality of wheel members 110. The wheel member mounting rods 114 can be connected to and extend between the first and second wheel member mounting arms 108, 109 so that each of the plurality of wheel 110 members are supported by at least one of the plurality of wheel member mounting rods 114 to overlie the respective one of the plurality of recesses 99 formed in the main body of the wheel hub 94. The wheel member mounting rod 114 can advantageously be made of aluminum, or any other type of strong and light weight material as understood by those skilled in the art.

The omni-directional wheel 90 of the present invention, the security vehicle 40, and the security vehicle system 30, can further advantageously include a pair of fasteners 116 each positioned to extend through the respective first and second wheel member mounting arms 108, 109 and into one of the plurality of wheel member mounting rods 114 to thereby fasten one of the plurality of wheel members 110 between the first and second wheel member mounting arms 108, 109. This advantageously secures each of the plurality of wheel members 110 between each of the plurality of pairs of mounting arms 107. The fasteners 116 can advantageously be pins or screws, for example. The pins can have a diameter that is large enough to provide a tight fit through portions of the first and second wheel member mounting arms 108,109, but loose enough so that when the fasteners 116 engage inner periphery portions of the wheel member mounting rods 114 positioned in medial portions of each of the plurality of wheel members 110, each of the plurality of wheel members 110 are still adapted to freely rotate independent of the wheel hub 94, and of the other plurality of wheel members 110.

When the plurality of omni-directional wheels 90 are connected to the main body of the security vehicle 40, the security vehicle 40 can advantageously be moved in multiple directions. The omni-directional wheels 90 are rotated at various predetermined speeds to adjust the direction and speed of the security vehicle 40. For example, if it is desired to move the security vehicle 40 in a transverse direction, then the omni-directional wheels on one side of the security vehicle 40 can be rotated faster than the omni-directional wheels 90 of the other side of the security vehicle 40. This advantageously allows the plurality of wheel members 110 on one side of the security vehicle to contact a support surface more often than the plurality of wheel members 110 on the other side of the security vehicle 40, thereby moving the security vehicle in the transverse direction.

The present invention further advantageously includes a method of maneuvering a security vehicle 40 having a base with a longitudinal axis, a low clearance, and at least one security device 65 connected thereto. The method can advantageously include moving the security vehicle 40 in first predetermined direction P₁ so that the longitudinal axis of the security vehicle 40 is substantially parallel to the path of travel of the security vehicle 40. The method can also advantageously include moving the security vehicle 40 in a second predetermined direction P₂ so that the longitudinal axis of the security vehicle 40 is substantially perpendicular to the path of travel of the security vehicle 40. The method can further advantageously include moving the security vehicle 40 in a third predetermined direction P₃ so that the longitudinal axis of the security vehicle 40 is substantially transverse to the path of travel of the security vehicle 40.

The method of maneuvering the security vehicle 40 can still further advantageously include maneuvering the security vehicle 40 in a predetermined area having a clearance of less than about twelve inches and retracting a security device cover 63 to thereby provide access to the security device 65 connected to the security vehicle 40. The method can also advantageously include extending a security device 65 to a position away from the security vehicle 40 and retracting the security device 65 to a position close to the security vehicle 40. The method can further advantageously include retracting the security device cover 63 to thereby cover the security device 65 connected to the security vehicle 40.

The present invention also advantageously includes a method of conducting surveillance with a security vehicle 40 having a base with a longitudinal axis, a lateral axis, at least one security device 65 connected thereto, and a predetermined effective range. The method includes moving the security vehicle 40 in a first predetermined direction P₁ so that the longitudinal axis is substantially parallel with a path of travel of the security vehicle 40 and the lateral axis is substantially perpendicular with the path of travel of the security vehicle 40. The method also includes extending the at least one security device 65 from the security vehicle 40 to thereby expand the predetermined effective range of the security vehicle 40. The method further advantageously includes moving the security vehicle 40 in a second predetermined direction P₂ so that the longitudinal axis is substantially perpendicular to the path of travel of the security vehicle 40 and the lateral axis is substantially parallel to the path of travel of the security vehicle 40.

The method of conducting surveillance also advantageously includes moving the security vehicle 40 in a third predetermined direction P₃ so that the longitudinal axis and the lateral axis are both substantially transverse the path of travel of the security vehicle 40 and retracting the at least one security device 65 to the security vehicle 40.

The present invention also advantageously includes a method of forming an omni-directional wheel 90 for providing multi-directional movement. The method of forming the omni-directional wheel 90 can advantageously include integrally forming a wheel hub 94 having a plurality of pairs of wheel member mounting arms 107 extending outwardly therefrom, forming a plurality of recesses 99 in outer periphery portions of the wheel hub 98, and connecting a plurality of wheel members 110 between each of the plurality of pairs of wheel member mounting arms 107, and operating each of the plurality of wheel members 110 independently of another one of the plurality of wheel members 110 and independently of the wheel hub 94.

The method can further advantageously include extending a wheel member mounting rod 114 through each of the plurality of wheel members 110 and connecting each of the plurality of wheel members 110 between one of the plurality of pairs of wheel member mounting arms 107 and inserting wheel member securing members 116 through the wheel member mounting arms 107 into the wheel member connecting rod 114 to thereby secure the wheel member 110 between one of the plurality of pairs of wheel member mounting arms 107.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as defined in the appended claims.

That claimed is:

1. A security vehicle system having a predetermined effective range, the security vehicle system comprising:
a remote controller having a control signal emitter positioned to emit a control signal; and
a security vehicle having a main body including a front, a rear, first and second sides extending between the front and rear, and a medial body portion having a cargo receiving area adapted to receive cargo, at least one security device connected to the main body, a plurality of omni-directional wheels connected to the main body to provide multi-directional movement of the security vehicle, a control signal receiver connected to the main body and positioned to receive the control signal emitted from the control signal emitter of the remote controller, and at least one drive assembly connected to the main body and to the plurality of omni-directional wheels and responsive to the control signal emitted by the control signal emitter of the remote controller to drive the plurality of omni-directional wheels, the security vehicle having a vertical height less than about twelve inches to thereby define a security vehicle having a low clearance so that the security vehicle can be readily positioned and maneuvered within a predetermined area having a low clearance.

2. The security vehicle system as defined in claim 1, wherein the main body further comprises a bottom, and a plurality of side walls positioned to extend upwardly from the bottom, and positioned adjacent each of the front, rear, first and second sides, and a top detachably connected to upper peripheries of the side walls.

3. The security vehicle system as defined in claim 2, wherein the cargo receiving area further comprises a cavity positioned between the sidewalls adjacent the front, rear, and first and second sides of the main body and wherein the at least one security device further comprises at least one surveillance device positioned to extend from the cargo receiving area to thereby increase the predetermined effective range of the security vehicle system.

4. The security vehicle system as defined in claim 3, wherein the side walls of the main body further comprise a plurality of security device access openings formed therein to thereby provide ready access of the security device positioned within the cargo receiving area to an area positioned exterior the cargo receiving area of the cargo receiving area and a plurality of security device access opening covers positioned to cover each of the plurality of security device access openings when not in use by the at least one security device.

5. The security vehicle system as defined in claim 4, wherein the security vehicle further comprises a pair of main axles defined by a front main axle positioned closely adjacent the front of the main body of the security vehicle and a rear main axle positioned closely adjacent the rear of the main body of the security vehicle, each of the pair of axles including a first end positioned adjacent the first side of the main body and a second end positioned adjacent the second side of the main body, and a plurality of omni-directional wheel connectors each connected to the respective first and second ends of the front and rear main axles, each including one of the respective first and second ends of one of the pairs of main axles extending from a medial portion thereof and a plurality of lugs positioned in an annular configuration to surround the main axle extending from the medial portion of the omni-directional wheel connector.

6. The security vehicle system as defined in claim 5, wherein each of the plurality of omni-directional wheels further comprises a wheel hub formed of a plastic material and including a hub main body having an axle mount formed in a medial portion thereof and positioned to receive one of the plurality of omni-directional wheel connectors to connect portions of each of the omni-directional wheels to the security vehicle, the hub main body including an outer periphery portion having a plurality of recesses formed therein, each having a substantially arcuate shaped recessed surface formed therein, and a plurality of pairs of spaced-apart wheel member mounting arms integrally formed of substantially the same plastic material as the wheel hub and positioned to surround the outer peripheries of the hub main body and extend outwardly therefrom, each of the plurality of pairs of wheel member mounting arms defined by a first wheel member mounting arm having a first predetermined elevation and a second wheel member mounting arm positioned substantially opposite the first wheel member mounting arm and having a second different predetermined elevation.

7. The security vehicle system as defined in claim 6, wherein each of the plurality of omni-directional wheels further comprises a plurality of separate and spaced-apart wheel members each formed of a plastic material including a wheel main body having an bulbous shape, a lateral axis, and a longitudinal axis being substantially longer than the lateral axis, each of the plurality of wheel members being connected between the first wheel member mounting arm having the first predetermined elevation, and the second wheel member mounting arm having the second different predetermined elevation and within a respective one of the plurality of recesses so that each of the plurality of wheel members is adapted to operate independently of other ones of the plurality of wheel members and independently of the wheel hub, and a plurality of wheel member mounting rods each positioned to extend through a medial portion of the wheel main body of each of the plurality of wheel members and connected to and extending between the first and second wheel member mounting arms so that each of the plurality of wheel members are supported by at least one of the plurality of wheel member mounting rods to overlie the respective one of the plurality of recesses formed in the main body of the wheel hub.

8. The security vehicle system as defined in claim 7, wherein the security vehicle further comprises a control signal receiver connected to the main body and positioned to receive the control signal emitted from the remote controller, and a control signal encoder positioned in communication with the control signal receiver to encode the control signal thereby defining an encoded control signal, the security vehicle being responsive to the encoded control signal.

9. The security vehicle system as defined in claim 8, wherein the security vehicle further comprises a plurality of power units interchangeably connected to the main body, the at least one drive assembly, the control signal receiver, and the control signal encoder, to provide power to the respective at least one drive assembly, the control signal receiver, and the control signal encoder.

10. The security vehicle system as defined in claim 9, wherein the security vehicle further comprises a track converter positioned to replace the plurality of omni-directional wheels with a pair of tracks, the track converter including a plurality of track receiving members, each having a size slightly larger than the size of each of the plurality of omni-directional wheels and positioned to connect to one of the plurality of omni-directional wheel connectors, and a pair of tracks each positioned to connect between at least a pair of track receiving members.

11. The security vehicle system as defined in claim 1, wherein the security device comprises at least one of the following: a bomb detection device, a bomb disarming device, a fire detection device, a fire extinguishing device, a poison detection device, a poison disabling device, a camera, a listening device, and a water purity testing device.

12. The security vehicle system as defined in claim 2, wherein the bottom, top, and side walls of the main body further comprise a substantially rectangular shape so that the security vehicle has a substantially rectangular shape.

13. A security vehicle having a predetermined effective range and a low vertical height to thereby define a low clearance so that the security vehicle can be readily positioned and maneuvered within a predetermined area having a low clearance, the security vehicle comprising:
a main body having a front, a rear, first and second sides extending between the front and rear, and a medial body portion having at least one security device connected thereto, the main body having a vertical height less than about twelve inches;
a forward drive unit having a front, a rear, first and second sides extending between the front and rear positioned adjacent the respective first and second sides of the main body, the rear of the forward drive interchangeably connected to the front of the main body so that the forward drive unit is positioned to extend from the front of the main body, respective first and second omni-directional wheels connected to the respective first and second sides of the forward drive unit, and respective first and second forward drive assemblies connected to the respective first and second omni-directional wheels to drive the respective first and second omni-directional wheels, the forward drive unit having a vertical height less than about twelve inches;
a rear drive unit having a front, a rear, first and second sides extending between the front and rear positioned adjacent the respective first and second sides of the main body, the front of the rear drive interchangeably connected to the rear of the main body so that the rear drive unit is positioned to extend from the rear of the main body, respective first and second omni-directional wheels connected to the respective first and second sides of the rear drive unit, and respective first and second rear drive assemblies connected to the respective first and second omni-directional wheels to drive the respective first and second omni-directional wheels, the rear drive unit having a vertical height less than about twelve inches, the forward drive unit and the rear drive unit being interchangeable so that the rear drive unit can be connected to the front of the main body and the forward drive unit can be connected to the rear of the main body; and
a plurality of power units positioned to interchangeably connect to the main body, the forward drive unit, and the rear drive unit, to provide power to the respective first and second drive assemblies of the respective forward and rear drive units, each of the plurality of power units having a vertical height less than about twelve inches.

14. The security vehicle as defined in claim 13, wherein the main body further comprises a bottom, and a plurality of side walls positioned to extend upwardly from the bottom, and positioned adjacent each of the front, rear, first and second sides, and a top detachably connected to upper peripheries of the side walls.

15. The security vehicle as defined in claim 14, wherein the cargo receiving area further comprises a cavity positioned between the sidewalls adjacent the front, rear, and first and second sides of the main body and wherein the at least one security device further comprises at least one surveillance device positioned to extend from the cargo receiving area to thereby increase the predetermined effective range of the security vehicle.

16. The security vehicle as defined in claim 15, wherein the side walls of the main body further comprise a plurality of security device access openings formed therein to thereby provide ready access of the security device positioned within the cargo receiving area to an area positioned exterior the cargo receiving area of the cargo receiving area and a plurality of security device access opening covers positioned to cover each of the plurality of security device access openings when not in use by the at least one security device.

17. The security vehicle as defined in claim 16, further comprising a pair of main axles defined by a front main axle connected between the respective first and second omni-directional wheels of the forward drive unit, and a rear main axle connected between the respective first and second omni-directional wheels of the rear drive unit of the main body of the security vehicle, the front and rear main axles including a first end positioned adjacent the first side of the main body and a second end positioned adjacent the second side of the main body, and a plurality of omni-directional wheel connectors each connected to the respective first and second ends of the front and rear main axles and including one of the respective first and second ends of one of the pairs of main axles extending from a medial portion thereof and a plurality of lugs positioned in an annular configuration surrounding the main axle extending from the medial portion of the omni-directional wheel connector.

18. The security vehicle as defined in claim 17, wherein each of the plurality of omni-directional wheels further comprises a wheel hub formed of a plastic material and including a hub main body having an axle mount formed in a medial portion thereof and positioned to receive one of the plurality of omni-directional wheel connectors to connect portions of each of the omni-directional wheels to the security vehicle, the hub main body including an outer periphery portion having a plurality of recesses formed therein, each having a substantially arcuate shaped recessed surface formed therein, and a plurality of pairs of spaced-apart wheel member mounting arms integrally formed of substantially the same plastic material as the wheel hub and positioned to surround the outer peripheries of the hub main body and extend outwardly therefrom, each of the plurality of pairs of wheel member mounting arms defined by a first wheel member mounting arm having a first predetermined elevation and a second wheel member mounting arm positioned substantially opposite the first wheel member mounting arm and having a second different predetermined elevation.

19. The security vehicle as defined in claim 18, wherein each of the plurality of omni-directional wheels further comprises a plurality of separate and spaced-apart wheel members each formed of a plastic material including a wheel main body having an bulbous shape, a lateral axis, and a longitudinal axis being substantially longer than the lateral axis, each of the plurality of wheel members being connected between the first wheel member mounting arm having the first predetermined elevation and the second wheel member mounting arm having the second different predetermined elevation and within a respective one of the plurality of recesses so that each of the plurality of wheel members is adapted to operate independently of other ones of the plurality of wheel members and independently of the wheel hub and a plurality of wheel member mounting rods each positioned to extend through a medial portion of the wheel main body of each of the plurality of wheel members and connected to and extending between the first and second wheel member mounting arms so that each of the plurality of wheel members are supported by at least one of the plurality of wheel member mounting rods to overlie the respective one of the plurality of recesses formed in the main body of the wheel hub.

20. The security vehicle as defined in claim 19, further comprising a control signal receiver connected to the main body and positioned to receive a control signal emitted from a remote controller, and a control signal encoder positioned in communication with the control signal receiver to encode the control signal thereby defining an encoded control signal, the security vehicle being responsive to the encoded control signal.

21. The security vehicle as defined in claim 8, wherein the security vehicle further comprises a plurality of power units interchangeably connected to the main body, the forward drive unit, the rear drive unit, the control signal receiver, and the control signal encoder, to provide power to the respective forward drive assembly, rear drive assembly, the control signal receiver, and the control signal encoder.

22. The security vehicle as defined in claim 21, further comprising a track converter positioned to replace the plurality of omni-directional wheels with a pair of tracks, the track converter including a plurality of track receiving members, each having a size slightly larger than the size of each of the plurality of omni-directional wheels and positioned to connect to one of the plurality of omni-directional wheel connectors, and a pair of tracks each positioned to connect between at least a pair of track receiving members.

23. The security vehicle as defined in claim 13, wherein the security device comprises at least one of the following: a bomb detection device, a bomb disarming device, a fire detection device, a fire extinguishing device, a poison detection device, a poison disabling device, a camera, a listening device, and a water purity testing device.

24. The security vehicle as defined in claim 14, wherein the bottom, top, and side walls of the main body further comprise a substantially rectangular shape so that the security vehicle has a substantially rectangular shape.

25. A security vehicle having a predetermined effective range and a low vertical height to thereby define a low clearance security vehicle, the security vehicle comprising:
a main body having a bottom, a top, a plurality of side walls extending therebetween, a front, a rear, first and second sides extending between the front and the rear, and a security device connected thereto;
a forward drive unit positioned to detachably and interchangeably connect to the front of the main body including a plurality of omni-directional wheels and a respective plurality of forward drive assemblies connected to the respective plurality of omni-directional wheels to drive the plurality of omni-directional wheels;
a rear drive unit positioned to detachably and interchangeably connect to the rear of the main body including a plurality of omni-directional wheels and a respective plurality of rear drive assemblies connected to the respective plurality of omni-directional wheels so that the forward drive unit can be interchanged with the rear drive unit;
a control signal receiver positioned on the main body to receive a control signal emitted from a remote controller;
a control signal encoder positioned in communication with the control signal receiver to encode the control signal thereby defining an encoded control signal, the security vehicle being responsive to the encoded control signal; and
a plurality of power units interchangeably connected to the main body, the forward drive unit, and the rear drive unit, the control signal receiver, and the control signal encoder, to provide power to the respective plurality of drive assemblies of the respective forward and rear drive units, the control signal receiver, and the control signal encoder.

26. The security vehicle as defined in claim 25, wherein at least one surveillance device is positioned to extend from the main body to thereby increase the predetermined effective range of the security vehicle system.

27. The security vehicle as defined in claim 26, wherein the side walls of the main body further comprise a plurality of security device access openings formed therein to thereby provide ready access of the security device positioned within the main body to an area positioned exterior the main body and a plurality of security device access opening covers positioned to cover each of the plurality of security device access openings when not in use by the at least one security device.

28. The security vehicle as defined in claim 27, further comprising a pair of main axles defined by a front main axle connected between the respective first and second omni-directional wheels of the forward drive unit and a rear main axle connected between the respective first and second omni-directional wheels of the rear drive unit of the main body of the security vehicle, the front and rear main axles including a first end positioned adjacent the first side of the main body and a second end positioned adjacent the second side of the main body, and a plurality of omni-directional wheel connectors each connected to the respective first and second ends of the front and rear main axles and including one of the respective first and second ends of one of the pairs of main axles extending from a medial portion thereof, and a plurality of lugs positioned in an annular configuration surrounding the main axle extending from the medial portion of the omni-directional wheel connector.

29. The security vehicle as defined in claim 28, wherein each of the plurality of omni-directional wheels further comprises a wheel hub formed of a plastic material and including a hub main body having an axle mount formed in a medial portion thereof and positioned to receive one of the plurality of omni-directional wheel connectors to connect portions of each of the omni-directional wheels to the security vehicle, the hub main body including an outer periphery portion having a plurality of recesses formed therein, each having a substantially arcuate shaped recessed surface formed therein, and a plurality of pairs of spaced-apart wheel member mounting arms integrally formed of substantially the same plastic material as the wheel hub and positioned to surround the outer peripheries of the hub main body and extend outwardly therefrom, each of the plurality of pairs of wheel member mounting arms defined by a first wheel member mounting arm having a first predetermined elevation and a second wheel member mounting arm positioned substantially opposite the first wheel member mounting arm and having a second different predetermined elevation.

30. The security vehicle as defined in claim 29, wherein each of the plurality of omni-directional wheels further comprises a plurality of separate and spaced-apart wheel members each formed of a plastic material including a wheel main body having an bulbous shape, a lateral axis, and a longitudinal axis being substantially longer than the lateral axis, each of the plurality of wheel members being connected between the first wheel member mounting arm having the first predetermined elevation and the second wheel member mounting arm having the second different predetermined elevation and within a respective one of the plurality of recesses so that each of the plurality of wheel members is adapted to operate independently of other ones of the plurality of wheel members and independently of the wheel hub, and a plurality of wheel member mounting rods each positioned to extend through a medial portion of the wheel main body of each of the plurality of wheel members and connected to and extending between the first and second wheel member mounting arms so that each of the plurality of wheel members are supported by at least one of the plurality of wheel member mounting rods to overlie the respective one of the plurality of recesses formed in the main body of the wheel hub.

31. The security vehicle as defined in claim 30, further comprising a track converter positioned to replace the plurality of omni-directional wheels with a pair of tracks, the track converter including a plurality of track receiving members, each having a size slightly larger than the size of each of the plurality of omni-directional wheels and positioned to connect to one of the plurality of omni-directional wheel connectors, and a pair of tracks each positioned to connect between at least a pair of track receiving members.

32. The security vehicle as defined in claim 25, wherein the security device comprises at least one of the following: a bomb detection device, a bomb disarming device, a fire detection device, a fire extinguishing device, a poison detection device, a poison disabling device, a camera, a listening device, and a water purity testing device.

33. The security vehicle as defined in claim 25, wherein the bottom, top, and side walls of the main body further comprise a substantially rectangular shape so that the security vehicle has a substantially rectangular shape.

34. A method of maneuvering a security vehicle having a base with a longitudinal axis, a low clearance, and at least one security device connected thereto, the method comprising:
moving the security vehicle in a first predetermined direction so that the longitudinal axis of the security vehicle is substantially parallel to the path of travel of the security vehicle;
moving the security vehicle in a second predetermined direction so that the longitudinal axis of the security vehicle is substantially perpendicular to the path of travel of the security vehicle; and
moving the security vehicle in a third predetermined direction so that the longitudinal axis of the vehicle is substantially transverse to the path of travel of the security vehicle.

35. The method as defined in claim 34, further comprising maneuvering the security vehicle in a predetermined area having a clearance of less than about twelve inches.

36. The method as defined in claim 35, further comprising retracting a security device cover to thereby provide access to the security device connected to the security vehicle.

37. The method as defined in claim 36, further comprising extending the security device to a position away from the security vehicle.

38. The method as defined in claim 37, further comprising retracting the security device to a position close to the security vehicle.

39. The method as defined in claim 38, further comprising retracting the security device cover to thereby cover the security device connected to the security vehicle.

40. A method of conducting surveillance with a security vehicle having a base with a longitudinal axis, a lateral axis, at least one security device connected thereto, and a predetermined effective range, the method comprising:
moving the security vehicle in a first predetermined direction so that the longitudinal axis is substantially parallel with a path of travel of the security vehicle and the lateral axis is substantially perpendicular with the path of travel of the security vehicle;
extending the at least one security device from the security vehicle to thereby expand the predetermined effective range of the security vehicle; and
moving the security vehicle in a second predetermined direction so that the longitudinal axis is substantially perpendicular to the path of travel of the security vehicle and the lateral axis is substantially parallel to the path of travel of the security vehicle.

41. The method as defined in claim 40, further comprising moving the security vehicle in a third predetermined direction so that the longitudinal axis and the lateral axis are both substantially transverse the path of travel of the security vehicle.

42. The method as defined in claim 41, further comprising retracting the at least one security device to the security vehicle.
